(19) United States
(12) Patent Application Publication
(10) Pub. No.: US 2021/0280840 A1
(43) Pub. Date: Sep. 9, 2021

(54) ELECTRODE GROUP AND BATTERY

(71) Applicant: KABUSHIKI KAISHA TOSHIBA, Tokyo (JP)

(72) Inventors: Masatoshi TANABE, Yokohama (JP); Kazuo SHIMOKAWA, Yokohama (JP); Takahiro AIZAWA, Yokohama (JP); Takashi ITO, Yokohama (JP)

(73) Assignee: KABUSHIKI KAISHA TOSHIBA, Tokyo (JP)

(21) Appl. No.: 17/094,884

(22) Filed: Nov. 11, 2020

(30) Foreign Application Priority Data
Mar. 9, 2020 (JP) 2020-039718

(51) Int. Cl. H01M 2/26; H01M 4/70; H01M 10/0587

(52) U.S. Cl. CPC H01M 2/263; H01M 2004/027; H01M 10/0587; H01M 4/70

(57) ABSTRACT

An electrode group includes a positive electrode, a negative electrode, and a current collecting tab. The current collecting tab is provided in one of the positive electrode and the negative electrode, and protrudes relative to the other of the positive electrode and the negative electrode. The current collecting tab is formed with one or more slit parts penetrating the current collecting tab in a thickness direction intersecting a protruding direction of the current collecting tab. Each of the one or more slit parts extends along a width direction intersecting both the protruding direction and the thickness direction. At each of the one or more slit parts, a circular portion is formed at at least one of the two ends in the width direction.

### CROSS-REFERENCE TO RELATED APPLICATIONS

This application is based upon and claims the benefit of priority from Japanese Patent Application No. 2020-039718, filed Mar. 9, 2020; the entire contents of which are incorporated herein by reference.

### FIELD

Embodiments relate generally to an electrode group and a battery.

### BACKGROUND

A battery such as a secondary battery includes an electrode group, and the electrode group includes a positive electrode and a negative electrode. In the electrode group, a current collecting tab protrudes. In the battery, the current collecting tab is electrically connected to an electrode terminal via a lead, etc. In the current collecting tab, a plurality of band-like parts are stacked.

When using the battery as described above, stress due to vibration of the electrode group is applied to the current collecting tab connected to the lead. In the electrode group used in the battery as described above, resistance to the stress applied to the current collecting tab and a joint between the lead and the current collecting tab must be improved.

### BRIEF DESCRIPTION OF THE DRAWINGS

FIG. 1 is a perspective view schematically showing an example of a battery according to an embodiment.

FIG. 2 is a schematic diagram showing a configuration of an electrode group of the battery of FIG. 1.

FIG. 3 is a schematic diagram showing a configuration of a current collecting tab of the electrode group of FIG. 2.

FIG. 4 is a perspective view schematically showing a part of the configuration of the current collecting tab of FIG. 3.

FIG. 5A is a schematic diagram showing an example of a battery according to a modification.

FIG. 5B is a schematic diagram showing a part of the battery shown in FIG. 5A.

### DETAILED DESCRIPTION

According to an embodiment, an electrode group includes a positive electrode, a negative electrode, and a current collecting tab. The current collecting tab is provided in one of the positive electrode and the negative electrode, and protrudes relative to the other of the positive electrode and the negative electrode. The current collecting tab is formed with one or more slit parts penetrating the current collecting tab in a thickness direction intersecting a protruding direction of the current collecting tab. Each of the one or more slit parts extends along a width direction intersecting both the protruding direction and the thickness direction. In each of the one or more slit parts, a circular portion is formed at at least one of the two ends of each slit in the width direction.

According to the embodiment, a battery including the above-described electrode group and an electrode terminal electrically connected to the current collecting tab of the electrode group is provided.

Hereinafter, the embodiment will be described with reference to the drawings.

### Embodiment

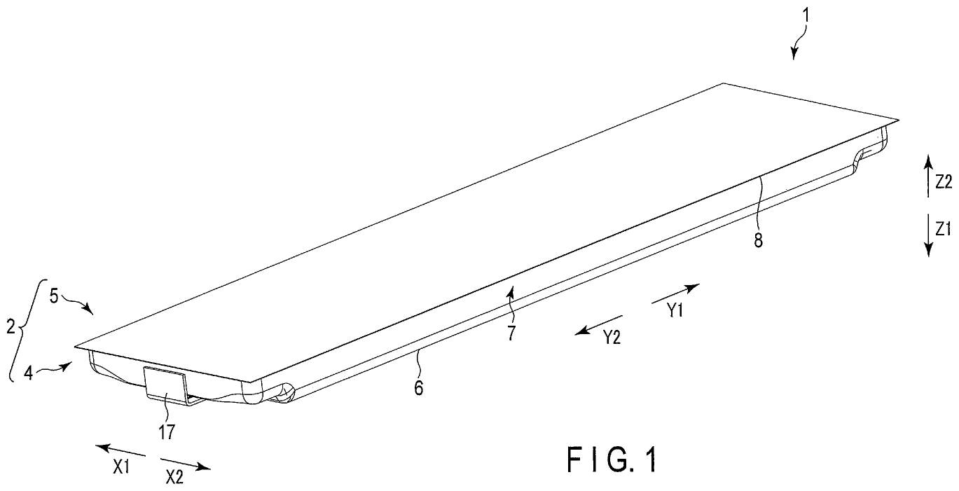

FIG. 1 shows an example of a battery 1. The battery 1 includes an outer container 2 and an electrode group 3 housed in the outer container 2. The outer container 2 is made of an electro-conductive material such as a metal, for example. The outer container 2 includes a cup member 4 and a lid member 5. In the battery 1 and the outer container 2, a depth direction (direction indicated by arrows X1 and X2), a lateral direction (direction indicated by arrows Y1 and Y2) intersecting (perpendicular or approximately perpendicular to) the depth direction, and a height direction (direction indicated by arrows Z1 and Z2) intersecting (perpendicular or approximately perpendicular to) both the depth direction and the lateral direction. In each of the battery 1 and the outer container 2, the dimension in the height direction is much smaller than each of the dimension in the depth direction and the dimension in the lateral direction.

The cup member 4 includes a bottom wall 6, a peripheral wall 7, and a flange 8. In the cup member 4, an inner cavity (not shown) is defined by the bottom wall 6 and the peripheral wall 7. The inner cavity opens toward a side opposite to a side where the bottom wall 6 is located in the height direction of the battery 1. The flange 8 protrudes from an end of the peripheral wall 7 on a side opposite to the bottom wall 6 to an outer circumferential side. The flange 8 is formed over the entire circumference in a circumferential direction of the outer container 2, and protrudes to the outer circumferential side over the entire circumference in the circumferential direction of the outer container 2. The lid member 5 is attached to the flange 8 from the side opposite to the side where the bottom wall 6 is located in the height direction of the battery 1. The lid member 5 faces the flange 8 from the side opposite to the bottom wall 6. The opening of the inner cavity of the cup member 4 is covered with the lid member 5.

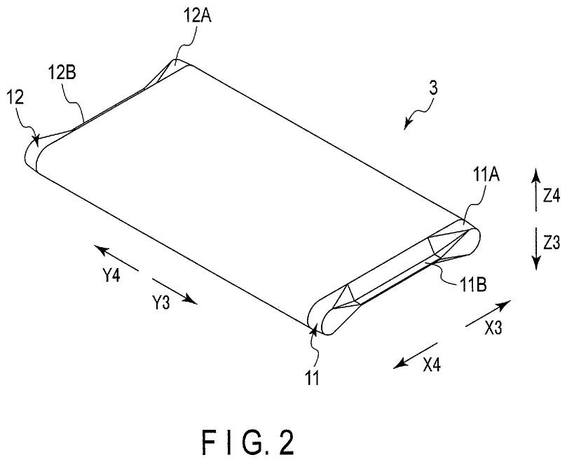

FIG. 2 shows an example of the electrode group 3. In FIG. 2, a slit part 31 to be described later is omitted. The electrode group 3 is formed into, for example, a flat shape, and includes a positive electrode 11 and a negative electrode 12. In the electrode group 3, a separator (not shown) is interposed between the positive electrode 11 and the negative electrode 12. The separator is made of a material having electrical insulation properties, and electrically insulates the positive electrode 11 from the negative electrode 12.

The positive electrode 11 includes a positive electrode current collector 11A such as a positive electrode current collecting foil, and a positive electrode active material-containing layer (not shown) supported on a surface of the positive electrode current collector 11A. The positive electrode current collector 11A is, but is not limited to, for example, an aluminum foil or an aluminum alloy foil, and has a thickness of about 10 μm to 20 μm. The positive electrode active material-containing layer includes a positive electrode active material, and may optionally contain a binder and an electro-conductive agent. Examples of the positive electrode active material include, but are not limited to, oxides, sulfides, and polymers, which can occlude and release lithium ions. The positive electrode current collector 11A includes a positive electrode current collecting tab 11B as a portion not supporting the positive electrode active material-containing layer.

The negative electrode 12 includes a negative electrode current collector 12A such as a negative electrode current collecting foil, and a negative electrode active material-containing layer (not shown) supported on a surface of the negative electrode current collector 12A. The negative electrode current collector 12A is, but not limited to, for example, an aluminum foil, an aluminum alloy foil, or a copper foil, and has a thickness of about 10 μm to 20 μm. The negative electrode active material-containing layer includes a negative electrode active material, and may optionally contain a binder and an electro-conductive agent. Examples of the negative electrode active material include, but are not limited to, metal oxides, metal sulfides, metal nitrides, and carbon materials, which can occlude and release lithium ions. The negative electrode current collector 12A includes a negative electrode current collecting tab 12B as a portion not supporting the negative electrode active material-containing layer.

In the electrode group 3 of one example, the positive electrode 11, the negative electrode 12, and the separator are wound around a winding axis with the separator sandwiched between the positive electrode active material-containing layer and the negative electrode active material-containing layer. Further, in another example, the electrode group 3 has a stack structure in which a plurality of positive electrodes 11 and a plurality of negative electrodes 12 are alternately stacked, and a separator is provided between the positive electrode 11 and the negative electrode 12. In the electrode group 3 shown as an example in FIG. 2, the positive electrode current collecting tab 11B protrudes to a side opposite to the negative electrode 12 and the separator. The negative electrode current collecting tab 12B protrudes to a side opposite to the positive electrode 11 and the separator. That is, the current collecting tabs 11B and 12B protrude to sides opposite to each other in the electrode group 3.

In the electrode group 3, a width direction (direction indicated by arrows X3 and X4) intersecting (perpendicular or approximately perpendicular to) a protruding direction (direction indicated by arrows Y3 and Y4) of the current collecting tabs 11B and 12B, and a thickness direction (direction indicated by arrows Z3 and Z4) intersecting (perpendicular or approximately perpendicular to) both the protruding direction of the current collecting tabs 11B and 12B and the width direction are defined. In the inner cavity, the electrode group 3 is arranged in a state in which the width direction coincides or approximately coincides with the depth direction of the battery 1 and the thickness direction coincides or approximately coincides with the height direction of the battery 1.

In the inner cavity, the electrode group 3 holds (is impregnated with) an electrolytic solution (not shown). The electrolytic solution may be a nonaqueous electrolytic solution obtained by dissolving an electrolyte in an organic solvent, or an aqueous electrolytic solution such as an aqueous solution. Instead of the electrolytic solution, a gel electrolyte may be used, or a solid electrolyte may be used. If a solid electrolyte is used as an electrolyte, the solid electrolyte is interposed between the positive electrode 11 and the negative electrode 12 instead of the separator in the electrode group 3. The positive electrode 11 is electrically insulated from the negative electrode 12 by the solid electrolyte.

In the battery 1, a pair of electrode terminals 17 are attached to an outer surface of the lid member 5 of the outer container 2. The electrode terminals 17 are made of an electro-conductive material such as a metal. One of the electrode terminals 17 is a positive electrode terminal of the battery 1, and the other of the electrode terminals 17 is a negative electrode terminal of the battery 1. An insulating member (not shown) is provided between each of the electrode terminals 17 and the lid member 5. Each of the electrode terminals 17 is electrically insulated from the outer container .2 including the lid member 5 by the insulating member. In FIG. 1, a bar member, which is a part of the electrode terminal 17, is shown.

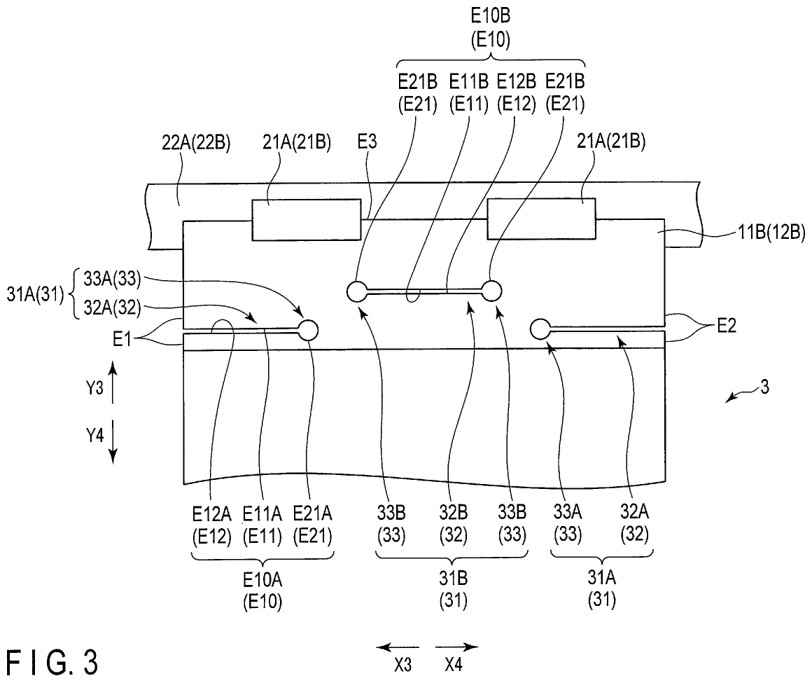

A corresponding one of backup leads 21A and 21B (see FIG. 3) is attached to each of the current collecting tabs 11B and 12B of the electrode group 3. The positive electrode current collecting tab 11B of the electrode group 3 is electrically connected to the positive electrode terminal, which is a corresponding one of the electrode terminals 17, via a positive electrode lead including the positive electrode-side backup lead 21A. The negative electrode current collecting tab 12B of the electrode group 3 is electrically connected to the negative electrode terminal, which is a corresponding one of the electrode terminals 17, via a negative electrode lead including a negative electrode-side backup lead 21B, etc. Each of the positive electrode lead and the negative electrode lead is made of an electro-conductive material such as a metal.

In each of the current collecting tabs 11B and 12B, a plurality of band-like parts are stacked. Before electrically connecting each of the current collecting tabs 11B and 12B to the corresponding one of the electrode terminals 17, the band-like parts are bound in each of the current collecting tabs 11B and 12B. Therefore, each of the current collecting tabs 11B and 12B is electrically connected to the corresponding one of the electrode terminals 17 via a corresponding one of the backup leads 21A and 21B in a state in which the band-like parts are bound.

In the inner cavity of the outer container 2, each of the positive electrode current collecting tab 11B and the positive electrode lead is electrically insulated from the outer container 2 by one or more insulating members (not shown). In the inner cavity of the outer container 2, each of the negative electrode current collecting tab 12B and the negative electrode lead is electrically insulated from the outer container 2 by one or more insulating members (not shown). The configuration of the battery of the embodiment is not limited to the above-described configuration. That is, the battery may be formed such that a slit part to be described later is provided in the current collecting tabs 11B and 12B.

FIG. 3 shows a plurality of slit parts 31 provided in the current collecting tab (the corresponding one of 11B and 12B). In the same manner as in FIG. 2, the protruding direction of the current collecting tabs 11B and 12B, width direction, and thickness direction are also defined in the electrode group 3 in FIG. 3. The backup lead (the corresponding one of 21A and 21B) is attached to the current collecting tab (the corresponding one of 11B and 12B) from a side to which the current collecting tab (the corresponding one of 11B and 12B) protrudes. The current collecting tab (the corresponding one of 11B and 12B) is connected to a connection lead (the corresponding one of a positive electrode-side connection lead 22A and a negative electrode-side connection lead 22B) via the backup lead (the corresponding one of 21A and 21B).

The current collecting tab (the corresponding one of 11B and 12B) includes tab edges E1 to E3 and the plurality of slit parts 31. The tab edge (first tab edge) E1 forms one end of the current collecting tab (the corresponding one of 11B and 12B) in the width direction of the electrode group 3. The tab edge (second tab edge) E2 forms an end of the current collecting tab (the corresponding one of 11B and 12B) on a side opposite to the tab edge E1 in the width direction of the electrode group 3. The tab edges E1 and E2 extend from a protrusion base of the current collecting tab (the corresponding one of 11B and 12B) to a protrusion end of the current collecting tab (the corresponding one of 11B and 12B). The tab edge (third tab edge) E3 forms the protrusion end of the current collecting tab (the corresponding one of 11B and 12B). The tab edge E3 extends from the tab edge E1 to the tab edge E2 along the width direction of the electrode group 3. In one example, the tab edges E1 and E2 are provided in parallel or approximately parallel to each other.

The current collecting tab (the corresponding one of 11B and 12B) is formed with the plurality of slit parts 31. Each of the slit parts 31 is formed by, for example, laser cutting, etc. Each of the slit parts 31 is formed along the width direction of the electrode group 3, and penetrates the current collecting tab (the corresponding one of 11B and 12B) in the thickness direction of the electrode group 3. That is, in the present embodiment, each of the slit parts 31 is an opening that penetrates the current collecting tab (the corresponding one of 11B and 12B) in the thickness direction of the electrode group 3. This opening is defined by an opening edge E10. Note that the plurality of slit parts 31 are formed to such an extent that the strength of the current collecting tab (the corresponding one of 11D and 12B) is not reduced even if they are formed in the current collecting tab (the corresponding one of 11B and 12B).

Each of the slit parts 31 includes an extension portion 32 and a circular portion 33. The extension portion 32 includes an edge (first edge) E11 and an edge (second edge) E12. The edges E11 and E12 extend along the width direction of the electrode group 3. The edge E11 faces the edge E12 from a side to which the current collecting tab (the corresponding one of 11B and 12B) protrudes. The edge E11 is arranged apart from the edge E12 on the protrusion end side of the current collecting tab (the corresponding one of 11B and 12B). Thereby, a portion between the edge E11 and the edge E12 forms an opening. In addition, the edges E11 and E12 form the opening edge E10. In one example, the edges E11 and E12 are provided in parallel or approximately parallel to each other.

The circular portion 33 is formed to be circular or approximately circular when viewed from the thickness direction of the electrode group 3, and penetrates the current collecting tab (the corresponding one of 11B and 12B) in the thickness direction of the electrode group 3. The circular portion 33 is formed at at least one end of the extension portion 32 in the width direction of the electrode group 3, and forms one end of each of the slit parts 31. Thus, the circular portion 33 forms an opening of the slit part 31. In addition, an opening edge E21 of the circular portion 33 is formed in a circumferential or approximately circumferential shape, and is connected to the edges E11 and E12 of the extension portion 32. Therefore, the opening edge E10 of each of the slit parts 31 is formed by the edges E11 and E12 of the extension portion 32 and the opening edge E21 of the circular portion 33.

It is preferable that each of the slit parts 31 be either one of a first slit part 31A or a second slit part 31B. The first slit part 31A includes an extension portion 32A including edges E11A and E12A, a circular portion 33A defined by an opening edge E21A, and an opening edge E10A, in the same manner as each of the slit parts 31. In addition, the second slit part 31B also includes an extension portion 32B including edges E11B and E12B, a circular portion 33B defined by an opening edge E21B, and an opening edge E10B, in the same manner as each of the slit parts 31.

An end of the first slit part 31A on a side opposite to the circular portion 33 in the width direction of the electrode group 3 is located at either one of the tab edge E1 or the tab edge E2 of the current collecting tab (the corresponding one of 11B and 12B). That is, both of an end of the edge E11A and an end of the edge E12A located on the side opposite to the circular portion 33 in the width direction of the electrode group 3 are located at one of the tab edge E1 and the tab edge E2. Here, since the edges E11A and E12A are formed apart from each other in the extension portion 32A, in a case where the end of the first slit part 31A is located at the tab edge E1, the first slit part 31A not only opens in the thickness direction of the electrode group 3 but also opens to the tab edge E1 side in the width direction of the electrode group 3. In a case where the end of the first slit part 31A is located at the tab edge E2, the first slit part 31A not only opens in the thickness direction of the electrode group 3 but also opens to the tab edge E2 side in the width direction of the electrode group 3. In addition, the other end on a side opposite to the one end of the slit part 31A is formed by the circular portion 33A. Thus, the opening edge E10A of the first slit part 31A is formed by the edges E11A and E12A of the extension portion 32, and the opening edge E21A of the circular portion 33. Note that in the first slit part 31A, the circular portion 33A is not formed at the end located at one of the tab edges E1 and E2 of the current collecting tab (the corresponding one of 11B and 12B).

As for the second slit part 31B, both of one end and an opposite side end in the width direction of the electrode group 3 are formed in the current collecting tab (the corresponding one of 11B and 12B). That is, neither ends of the second slit part 31B are located at any one of the tab edges E1 and E2. In this case, the circular portion 33B is formed at both of the two ends of the second slit part 31B (extension portion 32B). That is, the second slit part 31B includes two circular portions 33B. The opening edge E21B of each of the two circular portions 33B is connected to the edges E11B and E12B of the extension portion 32B. Thus, the opening edge E10B of the second slit part 31B is formed by the edges E11B and E12B of the extension portion 32B, and the respective opening edges E21B of the two circular portions 33B.

As shown in FIG. 3, the plurality of slit parts 31 (31A and 31B) are formed at positions offset from each other. That is, the opening edges E10 (E10A and E10B) of the slit parts 31 (31A and 31B) are not connected to each other. It is preferable that at least one of the slit parts (31A and 31B) be formed at a position offset from another slit part in the protruding direction of the current collecting tab (the corresponding one of 11B and 12B). In addition, it is preferable that at least one of the slit parts 31 (31A and 31B) be formed at a position offset from another slit part in the width direction of the electrode group 3. In one example, center planes (not shown) in the respective slit parts 31 (31A and 31B) in the width direction of the electrode group 3 are located at positions different from each other in the width direction of the electrode group 3.

In the present embodiment, “a slit part is formed at a position offset in the width direction of the electrode group 3” only means that a slit part should not completely overlap another slit part in the width direction of the electrode group 3. That is, a slit part may partially overlap another slit part in the width direction of the electrode group 3. As described above, an opening edge of a slit part is not connected to an opening edge of another slit part.

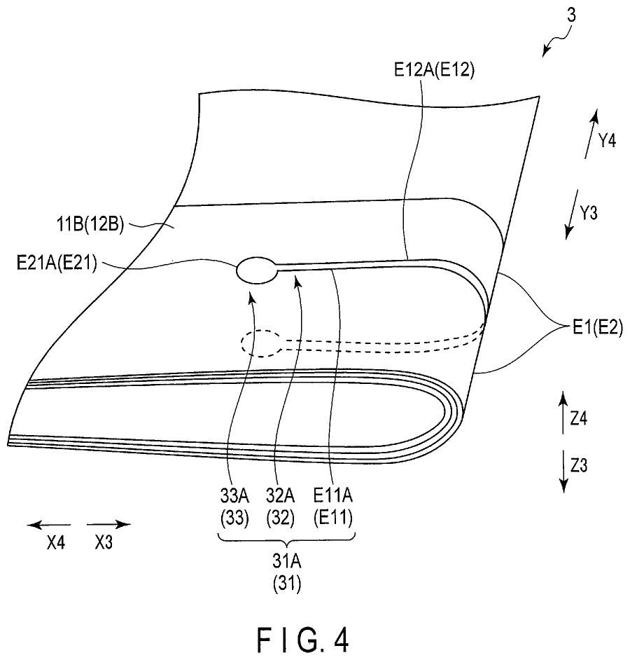

As shown in FIG. 4, in the electrode group 3 of one example, the positive electrode 11, the negative electrode 12, and the separator are wound around a winding axis. In this case, the current collecting tab (the corresponding one of 11B and 12B) is folded in the vicinity of the tab edge E1 or the tab edge E2 around the winding axis along the protruding direction of the current collecting tab. Accordingly, the first slit part 31A is formed to penetrate the current collecting tab (the corresponding one of 11B and 12B) in the thickness direction of the electrode group 3 also at the folded portion. Note that in a case where the above-described stack structure is used as the electrode group 3, there is no folded portion in the vicinity of the tab edge E1 or the tab edge E2.

In the case where the electrode group 3 is wound, the slit parts 31 (31A and 31B) may be formed before the electrode group 3 is wound or after the electrode group 3 is wound. In a case where the slit parts 31 (31A and 31B) are formed before the electrode group 3 is wound, the slit parts 31 (31A and 31B) are formed so as to be appropriately formed after the electrode group 3 is wound.

In the electrode group 3 of the present embodiment, the slit parts 31 are formed in the current collecting tab (the corresponding one of 11B and 12B). The slit parts 31 penetrate the current collecting tab (the corresponding one of 11B and 12B) in the thickness direction of the electrode group 3. At at least one of the two ends of the slit part 31 in the width direction of the electrode group 3, the circular portion 33, which is a circular shape when viewed from the thickness direction of the electrode group 3, is formed. Thus, even if stress acting in the protruding direction of the current collecting tab (the corresponding one of 11B and 12B) is applied to the current collecting tab (the corresponding one of 11B and 12B), the current collecting tab (the corresponding one of 11B and 12B) can be easily deformed. Therefore, it is possible to mitigate the stress applied to the current collecting tab (the corresponding one of 11B and 12B) by the deformation of the current collecting tab (the corresponding one of 11B and 12B). In addition, even if the stress is applied to the slit part 31, the stress applied to the end of the slit part 31 is mitigated by the circular portion 33. Thus, it is possible to effectively prevent a further slit from being formed in the current collecting tab (the corresponding one of 11B and 12B) beyond the end of the slit part 31. Therefore, in the electrode group 3, it is possible to improve resistance to the stress applied to the current collecting tab and a joint between the lead and the current collecting tab.

In the electrode group 3 of the present embodiment, it is preferable that the circular portion 33 be formed at both of the two ends of the slit part 31 in the width direction of the electrode group 3. Thereby, even if the stress is applied to the slit part 31, it is possible to effectively prevent a further slit from being formed in the current collecting tab (the corresponding one of 11B and 12B) beyond one end and an opposite side end of the slit part 31 in the width direction of the electrode group 3. Thus, in the electrode group 3, it is possible to further improve the resistance to the stress applied to the current collecting tab and the joint between the lead and the current collecting tab. In addition, even if the circular portion is formed only at one end of the slit part 31, if a side opposite to the one end is located at one of the tab edges E1 and E2 in the width direction of the electrode group 3, the same effect as in the case where the circular portion 33 is formed at both ends is exhibited.

In the electrode group 3 of the present embodiment, it is preferable that the plurality of slit parts 31 be formed in the current collecting tab (the corresponding one of 11B and 12B). Thereby, the current collecting tab (the corresponding one of 11B and 12B) can deform more easily, and the stress applied to the current collecting tab (the corresponding one of 11B and 12B) can thus be further mitigated by the deformation of the current collecting tab (the corresponding one of 11B and 12B). Thus, in the electrode group 3, it is possible to further improve the resistance to the stress applied to the current collecting tab and the joint between the lead and the current collecting tab.

In the electrode group 3 of the present embodiment, it is preferable that at least one of the slit parts 31 be formed at a position offset from another slit part in the protruding direction of the current collecting tab (the corresponding one of 11B and 12B). In addition, it is preferable that at least one of the slit parts 31 be formed at a position offset from another slit part in the width direction of the electrode group 3. Thereby, the current collecting tab (the corresponding one of 11B and 12B) can deform more easily, and the stress applied to the current collecting tab (the corresponding one of 11B and 12B) can thus be further mitigated by the deformation of the current collecting tab (the corresponding one of 11B and 12B). Therefore, in the electrode group 3, it is possible to further improve the resistance to the stress applied to the current collecting tab and the joint between the lead and the current collecting tab.

### Modification

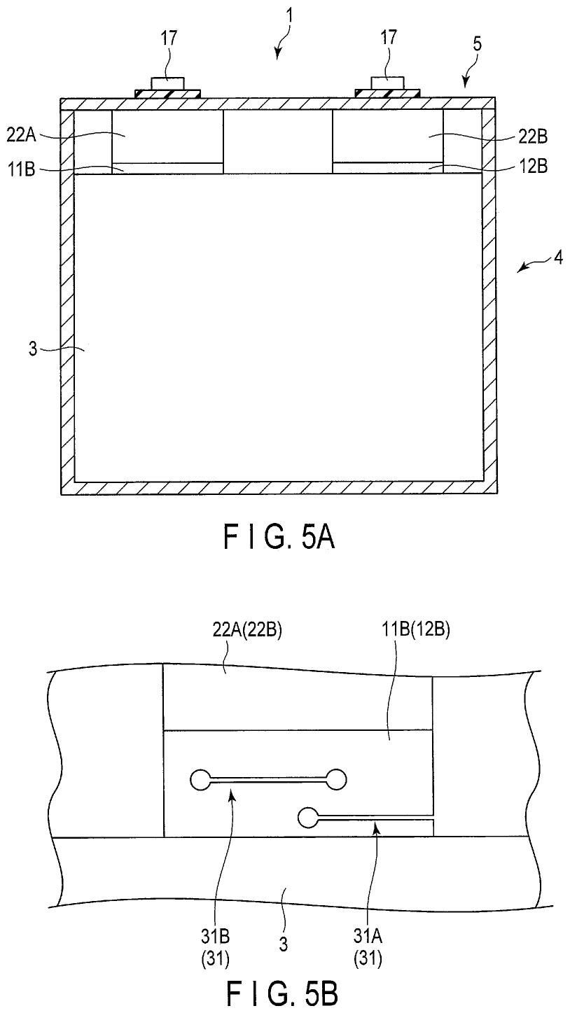

In the battery 1 shown in FIG. 5A, the positive electrode current collecting tab 11B and the negative electrode current collecting tab 12B protrude to the same side. The electrode group 3 can also be used for such a battery 1. In this case, as shown in FIG. 5B, in the same manner as in any of the above-described embodiments, etc., a plurality of slit parts 31 (31A and 31B) are formed in each of the current collecting tabs 11B and 12B. Thereby, the same effect as that of the above-described embodiment, etc. is exhibited.

In addition, even if the slit parts 31 are formed only in one of the positive electrode current collecting tab 11B and the negative electrode current collecting tab 12B, the same effect as that of the above-described embodiment, etc. is exhibited. Although the embodiment in which a plurality of slit parts 31 are formed in the current collecting tab (the corresponding one of 11B and 12B) has been described in the above, the same effect as that of the above-described embodiment is exhibited by one slit part 31 being formed in the current collecting tab (the corresponding one of 11B and 12B).

In at least one of the embodiments, an electrode group includes a positive electrode, a negative electrode, and a current collecting tab. The current collecting tab is provided in one of the positive electrode and the negative electrode, and protrudes relative to the other of the positive electrode and the negative electrode. The current collecting tab is formed with one or more slit parts penetrating the current collecting tab in a thickness direction intersecting a protruding direction of the current collecting tab. Each of the one or more slit parts extends along a width direction intersecting both the protruding direction and the thickness direction. At each of the one or more slit parts, a circular portion is formed at at least one of the two ends in the width direction. Thereby, in the electrode group, resistance to stress applied to the current collecting tab and a joint between a lead and the current collecting tab can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode group comprising:
a positive electrode and a negative electrode; and
a current collecting tab provided in one of the positive electrode and the negative electrode and protruding relative to another of the positive electrode and the negative electrode,
wherein
the current collecting tab is formed with one or more slit parts penetrating the current collecting tab in a thickness direction intersecting a protruding direction of the current collecting tab,
each of the one or more slit parts extends along a width direction intersecting both the protruding direction and the thickness direction, and
in each of the one or more slit parts, a circular portion is formed at at least one of two ends in the width direction.

2. The electrode group according to claim 1, wherein
the current collecting tab includes a first tab edge that forms one end of the current collecting tab in the width direction, and a second tab edge that forms an end on a side opposite to the first tab edge of the current collecting tab in the width direction, and
in at least one of the one or more slit parts, the circular portion is formed at one end in the width direction, and an end on a side opposite to the circular portion in the width direction is located at one of the first tab edge and the second tab edge.

3. The electrode group according to claim 1, wherein in at least one of the one or more slit parts, the circular portion is formed at both of the two ends in the width direction.

4. The electrode group according to claim 1, wherein
the one or more slit parts are a plurality of slit parts, and
at least one of the plurality of slit parts is formed at a position offset from another slit part in the protruding direction of the current collecting tab.

5. The electrode group according to claim 1, wherein
the one or more slit parts are a plurality of slit parts, and
at least one of the plurality of slit parts is formed at a position offset from another slit part in the width direction of the current collecting tab.

6. The electrode group according to claim 1, wherein
the current collecting tab includes a positive electrode current collecting tab protruding relative to the negative electrode, and a negative electrode current collecting tab protruding in the negative electrode to a side opposite to a side to which the positive electrode current collecting tab protrudes, and
the one or more slit parts are formed in at least one of the positive electrode current collecting tab and the negative electrode current collecting tab.

7. A battery comprising:
the electrode group according to claim 1; and
an electrode terminal electrically connected to the current collecting tab of the electrode group.
